(19) United States
(12) Patent Application Publication
(10) Pub. No.: US 2003/0163384 A1
(43) Pub. Date: Aug. 28, 2003

(54) System and method for enabling the provision of goods or services

(76) Inventor: Kendro Hendra, Jakarta (ID)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/296,991

(22) PCT Filed: May 10, 2001
(86) PCT No.: PCT/EP01/05302

(30) Foreign Application Priority Data
Jun. 2, 2001 (GB) 0013520.2

(51) Int. Cl. G06F 17/60; G06K 7/10

(52) U.S. Cl. 705/26; 235/462.01

(57) ABSTRACT

Receipt data corresponding to a purchase of predetermined goods or a service are downloaded to a mobile handset (MS 1) and displayed as a bar code. A vending delivery station (23) receives the receipt data from the handset and enables the provision of the purchase goods or service to the customer. In one example, cinema tickets are provided, printed by ticket printer (26).

### FIELD OF THE INVENTION

This invention relates to a system and method for enabling the provision of goods or services and has particular but not exclusive application to transactions in which a customer makes a purchase from a vendor, for example cinema or theatre tickets.

### BACKGROUND

It is known to purchase cinema and theatre tickets by telephone using a credit card. To buy tickets or make reservations, the customer telephones a ticket agency, selects a particular performance and purchases tickets at a selected price by giving credit card account details to which the ticket agency charges the price of the purchased tickets. The customer later collects the tickets at the cinema by presenting the credit card used to make the purchase. This usually involves queuing whilst each customer's credit card is checked individually. Recently, some cinemas have introduced credit card readers which are provided with details of the tickets purchased and, when a valid card is received, prints paper tickets, which are dispensed to the customer.

The present invention provides an improved way of dispensing goods and services to a customer.

### SUMMARY OF THE INVENTION

In accordance with the invention from a first aspect there is provided a method of supplying goods or services comprising transmitting to a mobile telecommunications device receipt data corresponding to predetermined goods or a service, transferring the data from the mobile device to a delivery station and enabling delivery of the goods or service by means of the delivery station as a function of the transferred data.

Thus, in accordance with the invention, receipt data may be provided to the mobile device and subsequently supplied to the delivery station, thus simplifying the procedures that are carried out at the delivery station.

The method may include displaying the receipt data on the mobile device and reading the display data so as to transfer it to the delivery station. The display of receipt data may be in code, for example a bar code. Alternatively, the transfer of receipt data from the mobile device to the delivery station may be via a wireless link, for example an infrared link or a radio link.

The invention has particular application to carrying out a transaction whereby a customer purchases goods or a service from a vendor and in another aspect, the method may include connecting a client device operated by the customer to a vending server which offers a purchasing opportunity provided by the vendor, conducting a transaction between the client device and the server to make a purchase, sending receipt data corresponding to a receipt for the purchase to the client device, transferring the receipt data from the client device to a vending delivery station for the goods or service, and enabling the provision of the purchase goods or service to the customer by means of the vending delivery station in response to the transferred receipt data.

The conducting of the transaction between the client and the server may include sending a debiting instruction for the client device to debit an account for the customer by a monetary amount for the purchase, and providing debit data as a function of whether the debiting of the account has been carried out. The debiting instruction may be sent to a bank server which then supplies the debit data to the vending server. The receipt data may be sent to the client device when the debit data indicates that the customer account has been debited for the purchase.

The receipt data may be sent to both the client device and the vending delivery station so that the receipt data from the client device and the receipt data received by the vending delivery station can be checked for integrity before the goods or service is actually dispensed to the customer.

The invention also includes a client device operable to perform the aforesaid method. The client device may be operable by a customer to carry out a transaction to purchase goods or a service from a vendor, the client device comprising: a transmitter-receiver configuration and a processor configured to be controlled by a customer to provide a connection through the transmitter-receiver to a vending server which offers a purchasing opportunity provided by the vendor, conduct a transaction to make a purchase, receive receipt data corresponding to a receipt for the purchase, and to permit transfer of the received receipt data to a vending delivery station so that the goods or service may be supplied to the customer from the vending delivery station.

The device may comprise a mobile telephone handset or a personal digital organiser (PDA). The device may be enabled to operate according to Wireless Application Protocol (WAP) as explained in more detail hereinafter.

The invention also includes a method of carrying out a transaction using the aforesaid mobile device.

In another aspect, the invention includes a vending server for offering a purchasing opportunity provided by a vendor for use in carrying out a transaction in which a customer uses a client device communicating with the server to purchase goods or a service from the vendor, and the purchase is delivered to the customer by means of a vending delivery station, the server comprising a processor for conducting a transaction between the client device and the server to make a purchase and to cause receipt data corresponding to a receipt for the purchase to be sent to the client device, for subsequently being transferred to the vending delivery station such that the goods or service may be provided to the customer from the vending delivery station in response to the transferred receipt data.

In a further aspect, the invention provides a vending delivery station for use in delivering goods or a service obtained in a transaction in which a customer uses a client device to make a purchase from a vendor, by connecting to a vending server which offers a purchasing opportunity provided by the vendor, and receipt data corresponding to a receipt for the purchase is sent to the client device, the vending delivery station including: an input to receive the receipt data from the client device, and means to enable delivery of the purchased goods or service to the customer in response to the transferred receipt data

The vending delivery station may include a ticket issuing device to issue tickets in response to the receipt data. The device may include a bar code reader in order to read a bar code displayed by a mobile device such as a mobile telephone.

### BRIEF DESCRIPTION OF THE DRAWINGS

In order that the invention may be more fully understood an embodiment thereof will now be described by way of example with reference to the accompanying drawings in which:

FIG. 1 is a schematic block diagram illustrating a mobile telephone handset which can communicate through PLMN to a WAP gateway;

FIG. 2 is a schematic block diagram of the circuitry of the mobile handset shown in FIG. 1;

FIG. 3 is a schematic illustration of a vending delivery station,

FIG. 4 is a schematic illustration of communication interchange between the various processes carried out during a vending operation,

FIG. 5 is a flow-chart of processes carried out at the handset and the vending delivery station; and

FIG. 6 is a schematic illustration of a bar code of receipt data displayed on the handset.

### DETAILED DESCRIPTION

System Overview

In the following example, a transaction is carried out in which cinema tickets are purchased by a customer using a mobile telecommunications device, which in this example comprises a cellular mobile telephone handset. Receipt data corresponding to a receipt for the purchased tickets is transmitted to the customer's handset and then transferred by the customer to a vending delivery station, which may be located at the cinema, that prints and delivers the tickets to the customer.

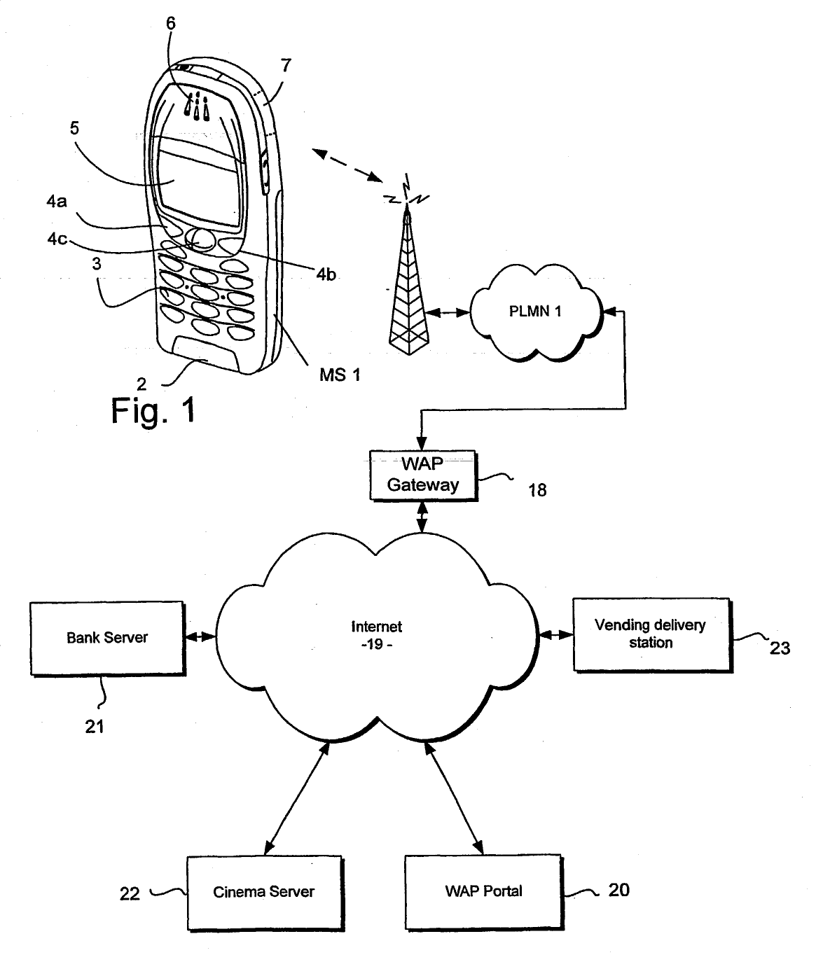

FIG. 1 illustrates the overall system. A mobile station in the form of a battery driven telephone cellular handset MS 1, is shown schematically in radio communication with PLMN 1.

The mobile handset MS1, includes a microphone 2, keypad 3, soft keys 4, a liquid crystal display device 5, ear-piece 6 and internal antenna 7. As will be explained in more detail, the handset 1 is WAP enabled.

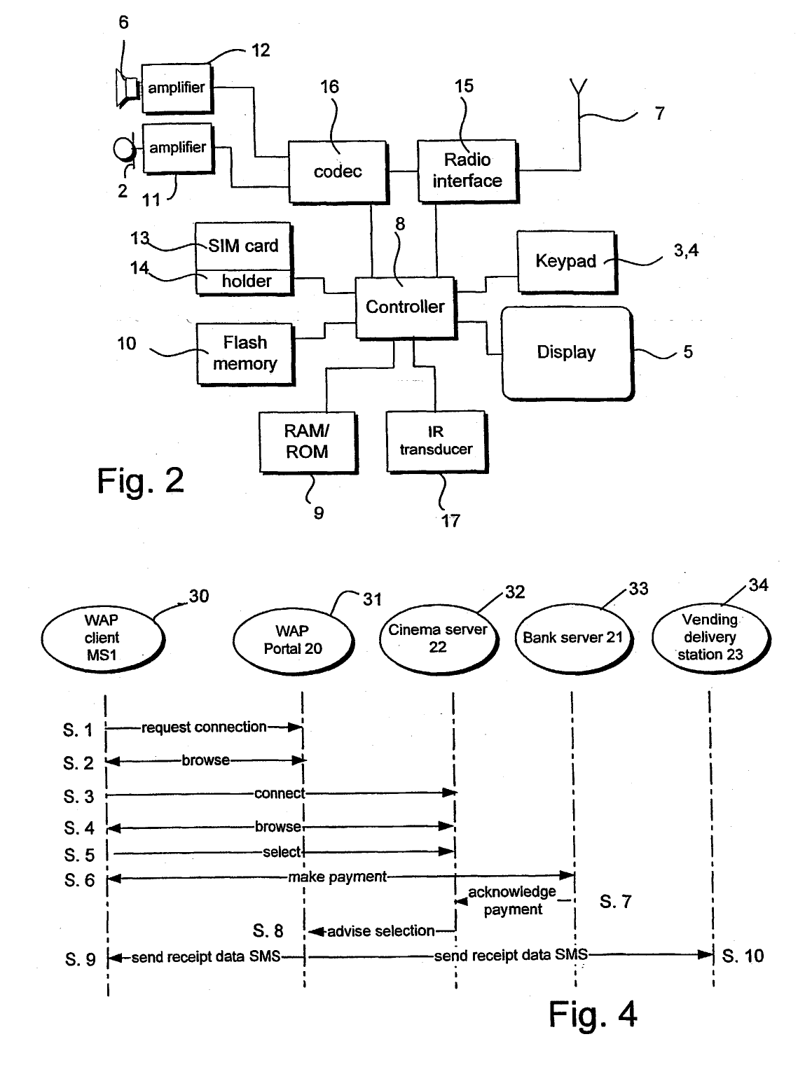

The circuitry of the handset MS 1 is shown in more detail in FIG. 2. Signal processing is carried out under the control of a digital micro controller 8 which has an associated RAM/ROM 9 and flash memory 10. Electrical analogue audio signals are produced by microphone 2 and amplified by pre-amplifier 11. Similarly, analogue audio signals are fed to the ear-piece 6 through an amplifier 12. The micro controller receives instruction signals from the keypad and so-called soft keys 4 and controls operation of the LCD display 5.

Information concerning the identity of the user is held on a smart card 13 in the form of a GSM SIM card which contains the usual GSM international mobile subscriber identity and encryption Kᵢ that is used for encoding the radio transmission in a manner well known per se. The smart card 13 may also store credit card information relating to a credit card account for the user. The card 13 is removably received in a SIM card holder 14.

Radio signals are transmitted and received by means of the antenna 7 connected through a r.f. stage 15 to a codec 16 configured to process signals under the control of a micro-controller 8. Thus, in use, for speech, the codec 16 receives analogue signals from the microphone amplifier 11, digitises them into a form suitable for transmission and feeds them to the r.f. stage 15 for transmission through antenna element 7 to PLMN 1 shown in FIG. 1. Similarly, signals received from PLMN 1 are fed through the antenna element to be demodulated by the rf stage 15 and fed to codec 16 so as to produce analogue signals fed to amplifier 12 and ear-piece 6.

The handset additionally includes an infra-red transducer 17 which can be used for short range communication with other devices through the agency of an infra-red link, as known in the art for connection to laptop computers PDAs and other peripheral devices under the control of the microcontroller 8.

The handset 1 is WAP enabled and capable of receiving data in a predetermined channel e.g. for GSM, at 9.6 Kbit/sec. Also, the handset may be configured to receive a high speed circuit switch data (HSCSD) according to the GSM Recommendations, at a data rate from 14.4-43.2 Kbit/sec. It will however be understood that the invention is not restricted to any particular data rate and that higher rates could be used. The WAP content and its applications are specified in a well known set of content formats based on familiar www content formats. WAP is disclosed in the Wireless Application Protocol Architecture Specification; version 30 Apr. 1998, published by the Wireless Application Protocol Architecture IS Working Group (see also http://www.wapforum.org/docs/technical.htm/arch-30-apr-98.pdf).

As known in the art, the WAP environment (WAE) provides a browser e.g. a micro-browser operable on the handset MS 1 as a client, for connection to WAP servers. The browser is configured to operate with WML which, as previously mentioned comprises a lightweight markup language similar to HTML but optimised for use in hand-held mobile terminals, WML script—a lightweight scripting language similar to JAVA Script™, wireless telephony application (WTA, WTAI) telephony services and programming interfaces, and content formats—a well known set of data formats including images, phone book records and calendar information.

The data can be downloaded to the browser from remote WAP servers which can be accessed through a WAP gateway 18 that acts as a proxy server. The handset MS 1 can access the gateway 18 by dialling a predetermined telephone number. The gateway provides access to a network 19, in this example the Internet, to which a number of WAP servers are connected. A WAP portal 20 acts as a WAP server and provides in effect a homepage for the display provided by the browser on handset MS 1. Also, as will be explained in more detail later, a bank server 21, cinema server 22 and a vending delivery station 23 are connected to the Internet for use in the ticket purchasing transaction.

The servers 18, 20, 21 and 22 provide WLM decks of cards corresponding to conventional pages of HTML such that a deck can be downloaded to the handset MS 1 and the individual cards manipulated for display by means of the keys 3, 4.

The WML data downloaded to the handset MS 1 may be held in the RAM 9 or flash memory 10. The microcontroller provides browser functionality and causes individual cards of the downloaded WML deck to be presented to the user in the browser on the screen of 5, to be manipulated by means of the keys 4.

Each of the servers 20, 21 and 22 has an associated universal resource locator (url) which can be accessed through the Internet 19 in a manner well-known per se.

WAP Portal (20)

The WAP portal 20 may act in effect as a homepage server for users of the mobile network PLMN 1 and offers downloadable WML data with information concerning goods and services provided by the operator of PLMN 1. The WAP portal 20 may constitute a walled garden of services and purchasing opportunities for customers using their mobile handsets. The WAP portal may additionally provide links (urls) for other suppliers for goods and services. In this example, the WAP portal 20 provides links for the cinema server 22 and bank server 21, which as explained later, are used in a procedure to purchase cinema tickets.

Cinema Server (22)

The cinema server 22 is operated by a cinema group which owns a number of cinemas that may be located at different geographical locations. The cinema server provides WML data corresponding to films or movies being shown at individual cinemas together with details of the showing times and seat prices. The cinema server need not actually be located at a particular cinema since its purpose is to provide information about the choice of films available to customers. In one example, the cinema server may provide preview information concerning the films being shown, which can be downloaded as WML data for display in the display device 5 of an individual customer's handset, to help the customer make a selection. Once a film, performance time and number and type of seats have been selected, the customer can purchase the tickets through the agency of the mobile handset MS 1, by interacting with the bank server 21.

Bank Server (21)

The bank server may be operated by a credit card company to facilitate purchase of goods or services from servers such as the cinema server 22. More than one banking server may be provided operated by different companies. The bank server may utilise credit card accounts, debit card accounts or other bank accounts at the choice of the customer. In this example, a credit card account is utilised. As previously explained, the SIM card 13 in the handset MS 1 contains credit card details for the customer using the handset in order to facilitate electronic interchange with the bank server 21.

Vending delivery Station (23)

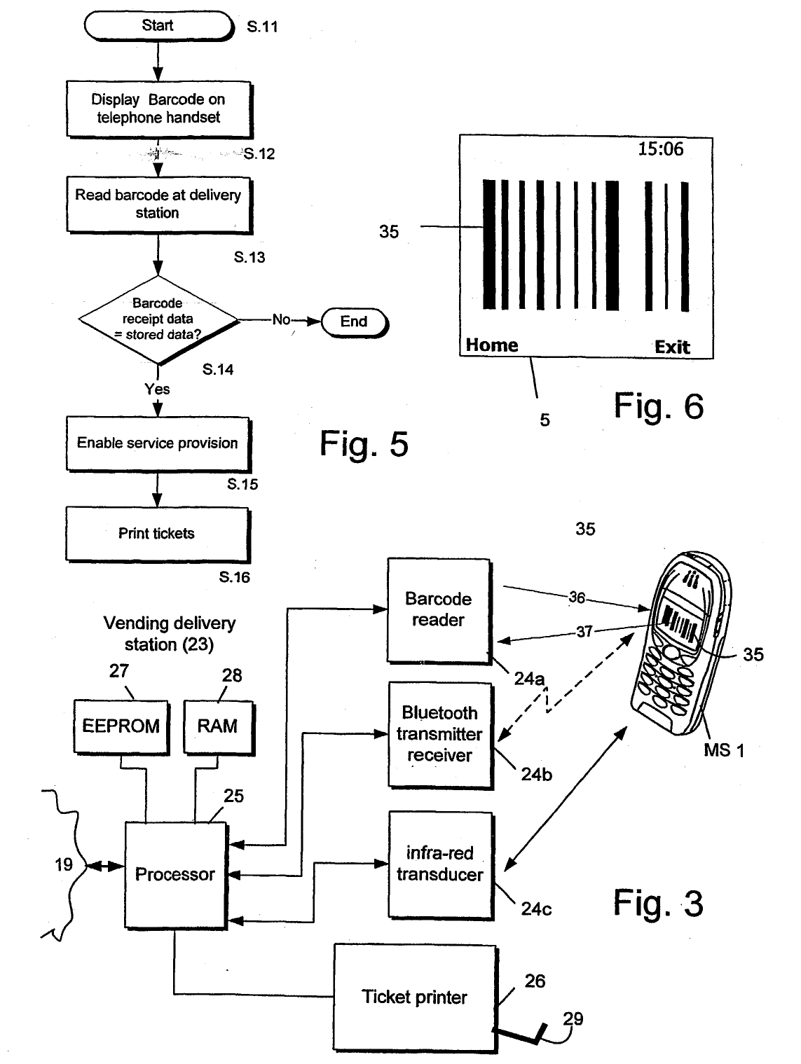

The vending delivery station 23 is configured to enable delivery of goods or services to a customer when their mobile handset MS 1 is presented to the station. In this example, the vending delivery station provides cinema tickets although other goods and services may be delivered, as explained in more detail later. The overall configuration of the vending delivery station 23 is shown in FIG. 3. The handset MS 1 is shown in close proximity to the station 23 which includes transducers 24a, b and c which communicate with the handset MS 1 such that receipt data corresponding to the purchase goods or services, is transferred to the vending delivery station from the handset. The receipt data is communicated to a processor 25 which drives a ticket printer 26 to print the cinema tickets, in this example. The processor 25 is also in communication with the Internet 19. The processor 25 has an associated EEPROM 27 which stores an operating program for the vending delivery station, and a RAM 28. Printed tickets are delivered to a tray 29.

The vending delivery station 23, in this example, may be located at the cinema to enable the customer to take the portable handset MS 1 to the cinema and use it to obtain the purchased cinema tickets. However, the vending delivery station need not necessarily be located at the cinema but at any convenient location to enable the customer to pick-up the purchased tickets.

Transaction Procedure

A transaction procedure for purchasing cinema tickets will now be described in more detail with reference to FIGS. 4 and 5. Referring to FIG. 4, it will be understood that the handset MS 1 runs a WAP client process 30. The WAP portal 20 provides a WAP portal process 31 and the cinema server 22 performs a process 32. The bank server 21 performs process 33 and a vending delivery process 34 is performed by the vending delivery station 23.

To initiate the transaction, the user of handset MS 1 dials the telephone number of WAP gateway 18 shown in FIG. 1 which in turn establishes a connection through Internet 19 to WAP portal 20. The process 31 run by WAP portal 20 provides a range of purchasing opportunities to the customer, namely the user of handset MS 1. These may include general shopping for a range of goods and services, some of which may be offered within the walled garden of the WAP portal and others may be provided by means of links to other servers. In this example, the sale of cinema tickets is offered by the separate cinema server 22 which runs the cinema server process 32 shown in FIG. 4.

The user can thus browse the various purchasing opportunities offered by the WAP portal process 31, as shown as step S2 in FIG. 4. Then, as step S3, the user selects the link associated with the cinema server 22 and establishes the connection to it.

Then, at step S4, the user browses the information presented by the cinema server process 32. The user is offered details of the times of performances of different films at a number of different cinemas which may be at the same or different geographical locations. The user is given details of the times of the performances, their contents, a range of ticket prices and, if appropriate, price concessions e.g. for students or other special interest groups. This information is displayed on the display 5 of the handset MS 1 using the WAP browser. The user can thus browse through the information presented by the cinema server process 32, as shown as step S4, using the soft keys 3, 4 to navigate through the cards of the WML deck downloaded to the browser from the cinema server process 32.

Then, at step S5, the user makes a selection, using the soft keys 3, 4 to select the performance, number of seats and seat price.

Payment for the selected tickets is then carried out, as shown as step S6. The cinema server process 32 provides a link to the bank server process 33 to enable the user to pay for the selected tickets using a credit card. The payment process is shown as step S6 that involves transfer of the user's credit card information from SIM card 13 to the bank server together with a debiting instruction to debit the account for the customer by a monetary amount for the purchase.

Assuming that the debiting of the account is successfully achieved, the bank server process 33 sends an acknowledgement of payment at step S7 to the cinema server process 32. The cinema server process 32 then, at step S8, advises the WAP portal process 31 of the purchased tickets, including details of the date, time of performance, number of seats and seat price.

Then, the WAP portal process 31 produces receipt data packaged as a short message service (SMS) message. In this example, the SMS is a graphic file representative of a bar code. Bar codes are well-known per se and are used to provide data in a coded form which can be read by a bar code reader. Bar codes are conventionally used on packaging in supermarkets and other stores. The bar code consists of a series of black and white stripes of different widths and spacings to signify digital code. The bar code can be read optically using a laser reader, which directs a laser beam onto the bar code and the reflected pattern of optical radiation is detected using a optical detector to provide an electrical signal in digital form, corresponding to the data in the bar code.

The SMS containing the receipt data is then transmitted from WAP portal 20 to the WAP client process 30 step S9. The receipt data is also sent to the vending delivery station 23 at step S10.

Thus, the receipt data is transferred to the handset MS 1 is only provided when the transaction has been successfully carried out. The receipt information contains the data needed to print the purchased tickets. The customer, i.e. the user of the handset can then collect the purchased tickets from the vending delivery station 23, by taking the handset MS 1 to the vending delivery station. As previously explained, the delivery station 23 may be located at the cinema so that the tickets can be collected immediately before the performance but the vending delivery station may be at any convenient location so that the tickets can be collected at a place convenient to the customer.

When the receipt data is received at step S9 in FIG. 4 by the handset MS 1, it is stored in flash memory 10 (FIG. 2). When the user reaches the vending delivery station 23, the keypad 3, 4 is operated to actuate a program held in RAM 9, which recalls the stored receipt data and displays it as a bar code. This process is shown at step S11 and s12 in FIG. 5. The resulting display is shown in FIG. 6. Bar code 35 is displayed on the display device 5.

Then, the handset MS 1, displaying the bar code 35, is brought into close proximity with bar code reader 24a as shown in FIG. 3. The bar code reader 24a includes a laser which directs a scanning beam 36 towards the display 5 of the handset MS 1, and a resulting reflected beam 37, modulated by the bar code pattern, is detected by the bar code reader. As a result, the bar code reader develops a digital electrical signal corresponding to the data in the bar code, which is fed to processor 25. The reading operation performed by the bar code reader 24a is controlled by the processor 25 which runs a reading program held in RAM 27 to perform the reading process. The reading operation is shown as step S13 in FIG. 5.

As previously explained, the receipt data SMS is sent at step S11 (FIG. 4) to the ending delivery station 23 and is stored in RAM 28. At step S14, the receipt data received at step S10 is compared with the receipt data read by the bar code reader 24a. If the data correspond, the service provision, i.e. printing of tickets is enabled at step S15. Otherwise the process terminates. Then, at step S16, the processor 25 instructs the ticket printer 26 to print the cinema tickets according to the data read by the bar code reader 24a and the customer collects them from tray 29.

Many modifications and variations of the described system are possible. Whilst in the described system, a bar code reader is used to transfer the receipt data from the handset MS 1 to the vending delivery station, the transfer can be achieved in a number of different ways. For example, the controller 8 shown in FIG. 2 can read the stored SMS receipt data from the flash memory 10 and direct the data to the infra-red transducer 17 so as to be transmitted via a infra-red link to infra-red transducer 24c shown in FIG. 3. Alternatively, the handset may include Bluetooth transmitter (not shown), capable of transmitting on a low power local RF link to the Bluetooth transmitter receiver unit 24b shown in FIG. 3.

The invention is not limited to use of mobile telephone handset and can be used for other mobile telecommunication devices such as PDA's.

Furthermore, the invention is not limited to GSM cellular networks. Any suitable PLMN may be used including UMTS. The increased bandwidth available with UMTS as compared with conventional systems, permits enhanced functionality. For example, when browsing the cinema options at step S4 in FIG. 4, it would be possible to download MPEG files to the browser at the handset MS 1 to enable the user to view a film preview from the display 5. Also, other mobile data networks could be used, such as the Japanese I-Mode system.

Furthermore, the receipt data need not be displayed as a bar code 35. Instead it may be displayed as a numerical code which can be manually keyed by the user into a keypad (not shown) at the vending delivery station 23.

The invention can also be performed without the use of a mobile handset. For example, a conventional personal computer (PC) which may or may not be a mobile device connected to the Internet can be used and the receipt data may be printed either as a bar code or in another suitable form on a sheet of paper and then taken by the customer to the vending delivery station so that the receipt data can be transferred thereto from the paper sheet.

The invention need not involve the printing of tickets. For example, the enabling output (step S15) of processor 25 may be used to open a barrier gate to allow the customer entry into the cinema, or in other situations such as railway stations or for other mass transit systems.

The invention is not restricted to the provision of tickets and can be used for vending many different goods and services, for example airline tickets, train tickets and goods from stores. Furthermore, the invention is not restricted to vending operations. The receipt data may be supplied to the client device process 30 in a process which does not necessarily involve a financial transaction. For example, discount vouchers may be provided as a bar code to a user which may be redeemed at a vending delivery station e.g. in a supermarket. Also, the system may be used to deliver free ticketing for exhibitions and the like. Many other uses and modifications of the described system fall within the scope of the claimed invention.

1. A method of supplying goods or services comprising transmitting to a mobile telecommunications device receipt data corresponding to predetermined goods or a service, transferring the data from the mobile device to a delivery station and enabling delivery of the goods or service by means of the delivery station as a function of the transferred data.

2. A method according to claim 1 including displaying the receipt data on the mobile device and reading the displayed data so as to transfer it to the delivery station.

3. A method according to claim 2 including displaying the receipt data in code

4. A method according to claim 1 including transferring the receipt data from the mobile device to the delivery station via a wireless link.

5. A method of caring out a transaction whereby a customer purchases goods or a service from a vendor, comprising: connecting a client device operated by the customer to a vending server which offers a purchasing opportunity provided by the vendor, conducting a transaction between the client device and the server to make a purchase, sending receipt data corresponding to a receipt for the purchase to the client device, transferring the receipt data from the client device to a vending delivery station for the goods or service, and enabling the provision of the purchased goods or service to the customer by means of the vending delivery station in response to the transferred receipt data.

6. A method according to claim 5 wherein the conducting of the transaction between the client and the server includes sending a debiting instruction to debit an account for the customer by a monetary amount for the purchase, and providing debit data as a function of whether the debiting of the account has been carried out.

7. A method according to claim 6 including sending the debiting instruction to a banking sever, and supplying the debit data from the banking server to the vending server.

8. A method according to claim 6 or 7 including only sending the receipt data to the client device when the debit data indicates that the customer account has been debited for the purchase.

9. A method according to any one of claims 5 to 8 including sending the receipt data to the client device and the vending delivery station from the vending server.

10. A method according to any one of claims 5 to 9 wherein the client device comprises mobile telecommunications apparatus and the method includes transferring the receipt data from the mobile apparatus to the vending delivery station.

11. A method according to claim 10 including the receipt data on the apparatus to enable the transfer of the receipt data to the vending delivery station.

12. A method according to claim 11 including displaying the data as a code.

13. A method according to claim 12 including displaying the receipt data as a bar code.

14. A method according to any one of claims 5 to 13 including using a data reader at the vending delivery station to read the receipt data from the client device.

15. A method according to any one of claim 9 including sending the receipt data from the vending server to the vending delivery station, comparing the receipt data from the client device with the data received by the vending delivery station from the server, and enabling the provision of the purchased goods or service to the customer by means of the vending delivery station in dependence upon the outcome of the comparison.

16. A client device operable by a customer to carry out a transaction to purchase goods or a service from a vendor, the client device comprising: a transmitter-receiver configuration and a processor configured to be controlled by a customer to provide a connection through the transmitter-receiver to a vending server which offers a purchasing opportunity provided by the vendor, conduct a transaction to make a purchase, to receive receipt data corresponding to a receipt for the purchase, and to permit transfer of the received receipt data to the vending delivery station so that the goods or service may be supplied to the customer from the vending delivery station.

17. A device according to claim 16 including a display operable to display the receipt data.

18. A device according to claim 16 or 17 wherein the display is operable to display the receipt data as a code.

19. A device according to claim 16, 17 or 18 wherein the display is operable to display the receipt data as a bar code.

20. A device according to any one of claims 16 to 19 and comprising a mobile telephone handset.

21. A device according to any one of claims 16 to 20 and comprising a PDA.

22. A device according to any one of claims 16 to 21, which is WAP enabled.

23. A device according to any one of claims 16 to 22 wherein the receiver is configured to receive the receipt data as a data message.

24. A device according to any one of claims 16 to 23 operable to transfer the receipt data to the delivery station over a wireless link.

25. A method of operating a client device by a customer to carry out a transaction to purchase goods or a service from a vendor, the method comprising conducting a transaction with a vending server to make a purchase, receiving receipt data corresponding to a receipt for the purchase, and supplying the receipt data received by the client device to the vending delivery station so that the goods or service may be supplied to the customer from the vending delivery station.

26. A method according to claim 25 including displaying the receipt data.

27. A method according to claim 25 or 26 including displaying the receipt data in code.

28. A method according to claim 25, 26 or 27 including displaying the receipt data in a bar code.

29. A method according to any one of claims 25 to 28 including causing the receipt data received by the client device to be input into the vending delivery station.

30. A computer program to be run on a client device to carry out the method claimed in any one of claims 25 to 29.

31. A vending server for offering a purchasing opportunity provided by a vendor for use in carrying out a transaction in which a customer uses a client device communicating with the server to purchase goods or a service from the vendor, and the purchase is delivered to the customer by means of a vending delivery station, the server comprising a processor for conducting a transaction between the client device and the server to make a purchase and to cause receipt data corresponding to a receipt for the purchase to be sent to the client device, for subsequently being transferred to the vending delivery station such that the goods or service may be provided to the customer from the vending delivery station in response to the transferred receipt data.

32. A method of operating a vending server that offers a purchasing opportunity provided by a vendor wherein a customer uses a client device communicating with the server to purchase goods or a service from the vendor, and the purchase is delivered to the customer by means of a vending delivery station, the method comprising conducting a transaction between the client device and the server to make a purchase and causing receipt data corresponding to a receipt for the purchase to be sent to the client device, for subsequently being transferred to the vending delivery station such that the goods or service may be provided to the customer from the vending delivery station in response to the transferred receipt data.

33. A method according to claim 32 including offering the customer a number of purchasing opportunities, whereby the customer makes a selection, and the receipt data includes information relating to the selection made by the customer.

34. A computer program to be run on a vending server to carry out the method claimed in claim 32 or 33.

35. A signal comprising a carrier modulated with receipt data produced by a method according to claim 32, 33 or 34.

36. A vending delivery station for use in delivering goods or service obtained in a transaction in which a customer uses a client device to make a purchase from a vendor, by connecting to a vending server which offers a purchasing opportunity provided by the vendor, and receipt data corresponding to a receipt for the purchase is sent to the client device, the vending delivery station including: an input to receive the receipt data from the client device, and means to enable delivery of the purchased goods or service to the customer in response to the transferred receipt data.

37. A vending delivery station according to claim 36 including a comparator to compare the receipt data transferred from the client device with the receipt data received from the vending server to indicate whether the goods or service should be supplied to the customer.

38. A station according to claim 36 or 37 wherein the input comprises a bar code reader.

39. A station according to any one of claims 36 to 39 including a ticket issuing device to issue tickets in response to the receipt data.

40. A method of operating a vending delivery station for use in delivering goods or service purchased in a transaction in which a customer uses a client device to make the purchase from a vendor, by connecting to a vending server which offers a purchasing opportunity provided by the vendor, and receipt data corresponding to a receipt for the purchase is sent to the client device, the method comprising receiving the receipt data from the client device, enabling delivery of the purchased goods or service to the customer in response to the transferred receipt data.

41. A computer program to be run on data processing apparatus to carry out the method claimed in claim 40.

42. A system for carrying out a transaction whereby a customer purchases goods or a service from a vendor, comprising: a client device operable by the customer to connect to a vending server which offers a purchasing opportunity provided by the vendor, so as to conduct a transaction to make a purchase, means for sending receipt data corresponding to a receipt for the purchase to the client device, a vending delivery station for the goods or service, means for transferring the receipt data from the client device to the vending delivery station, and means for providing the goods or service to the customer from the vending delivery station.

43. A banking server configured to co-operate in the performance of a method claimed in claim 7.

44. A mobile telecommunications device operable to receive receipt data corresponding to predetermined goods or a service, and operable to transfer the receipt data to a delivery station to enable delivery of the goods or service by means of the delivery station as a function of the transferred data.

45. A device according to claim 44 including a display device configured to display the receipt information as an optically readable code for transfer to the delivery station by means of an optical reader.

46. A device according to claim 45 wherein the display device is operable to display the receipt data as a bar code.
